(19) United States
(12) Patent Application Publication
(10) Pub. No.: US 2023/0146648 A1
(43) Pub. Date: May 11, 2023

(54) IMMERSIVE LEARNING APPLICATION FRAMEWORK FOR VIDEO WITH WEB CONTENT OVERLAY CONTROL

(71) Applicant: IntelliMedia Networks, Inc., Leesburg, VA (US)

(72) Inventors: Darshan Sedani, Cerritos, CA (US); Teodros Gessesse, Leesburg, VA (US); Devang Ajmera, Gujaratvv (IN); Joy Shah, Gujarat (IN); Rajkumar Ramakrishnan, Gujarat (IN)

(73) Assignee: IntelliMedia Networks, Inc., Leesburg, VA (US)

(21) Appl. No.: 17/839,129

(22) Filed: Jun. 13, 2022

Related U.S. Application Data
(63) Continuation of application No. 17/839,025, filed on Jun. 13, 2022.
Application No. 17/839,025 is a continuation of application No. 17/838,924, filed on Jun. 13, 2022.
Application No. 17/838,924 is a continuation of application No. 17/592,371, filed on Feb. 3, 2022.
Application No. 17/592,371 is a continuation of application No. 17/592,296, filed on Feb. 3, 2022.
Application No. 17/592,296 is a continuation of application No. 17/523,504, filed on Nov. 10, 2021.

(51) Int. Cl. G09B 5/06

(52) U.S. Cl. CPC G09B 5/065

(57) ABSTRACT

Immersive Learning Application Framework for Video with Web Content Overlay Control is an interactive software module providing a method enabling a video delivered to a connected device from a centralized system to obtain supplemental information about objects displayed in the video, or about a subject which is referred to in the video, or an additional piece of information used to collect or take inputs from the viewer through the connected devices managed by the viewer. These are frames that either contain local HTML/CSS/JavaScript content, or embedded HTML content for widgets such as maps.

### CROSS-REFERENCE TO RELATED APPLICATIONS

This application is a continuation application of U.S. patent application Ser. No. 17/839,025, filed Jun. 13, 2022, which is a Continuation of U.S. patent application Ser. No. 17/838,924, filed Jun. 13, 2022, which is a Continuation of U.S. patent application Ser. No. 17/592,371, filed Feb. 3, 2022, which is a Continuation of U.S. patent application Ser. No. 17/592,296, Feb. 3, 2022, which is a Continuation of U.S. patent application Ser. No. 17/523,504, filed Nov. 10, 2021, the entire disclosures of which are herein incorporated by reference as a part of this application.

### FIELD

This invention is in the field of the interaction among and between educational software systems, learning systems, courseware management, informational communications and visualization systems, and virtual reality presentation system software, students, teachers, and learning system administrators.

### DESCRIPTION OF RELATED ART

As the Internet has grown in speed and computing power, and with the rise of cloud-based data storage and software as a service, online education has become increasingly enabled. Many efforts at standardizing online education and providing tools to enable multiple kinds of course materials to be mixed together have arisen. A critical threshold has also been reached where networking bandwidth and data transfer speeds of massive amounts of data are now sufficient to allow blending of live data streams. These factors have served to open a wide range of opportunities for designing and serving so-called massive open online courses to students worldwide.

Another convergence of technology is also maturing: the widespread availability of multiple kinds of user devices such as laptop computers, mobile phones, mobile tablets of various kinds, next-generation television program management services (so-called over-the-top (“OTT”) services), and virtual reality devices and related services. These devices are becoming sufficiently commonplace that widespread familiarity with their use is an enabler for convergent inter-operation of such device to enhance information delivery and interactivity. Users of such devices now often possess sufficient skills to be able to operate multiple devices and coordinate information between them with ease.

Taken together, these factors provide opportunities for development of inter-operating education systems which take advantage of multiple information delivery modalities including plain text, interactive text, audio, video, collaborative workspaces, and various combinations of live interactions between students and teachers while sharing and even contributing to information flows displayed on multiple devices simultaneous.

Such new systems serve to enhance learning rates of student, collaboration rates among professionals, and may even serve to enhance the rate of new discoveries in science by scientific research communities.

The Immersive Learning Application Framework for Video with Web Content Overlay Control disclosed hereunder is a component of one such integrative software system in this new genre.

### SUMMARY

Immersive Learning Application Framework for Video with Web Content Overlay Control (ILAFVWO) is a component system of Immersive Learning Application (ILA), which in turn is a cloud-based integrated software system providing a rich context for education of trainees, employees in enterprise organizations, students in institutional settings, as well as individual students, through the operation of courseware, testing, skills validation and certification, courseware management, and inter-personal interactions of students and teachers in various ways. The core concept is providing a learning environment which is immersive in the sense that the student can utilize every available communications and display technology to be fully immersed in a simulated or artificial environment. The student is able to tune this environment to his/her own optimum style of information absorption.

Immersive Learning Application Framework for Video with Web Content Overlay Control or shortly know as ILAFVWO is an interactive software module providing a method enabling a video delivered to a connected device from a centralized system to obtain supplemental information about objects displayed in the video, or about a subject which is referred to in the video, or an additional piece of information used to collect or take inputs from the viewer through the connected devices managed by the viewer. The additional information may include a detailed description of an object displayed inside the video or subject which is referred to in the video, a means to display an additional piece of information to collect or take inputs from users using the connected devices managed by the user.

ILAFVWO supports parent-child or parent-children relationships among web contents overlaid on video, such that the content in any one device active in the system may be cast in the role of a parent content and be displayed as child content on the other devices simultaneously active within the system. This type of relationship among content displays may be from any device with its distinct operating to any other device with its correspondingly distinct operating system.

### BRIEF DESCRIPTION OF THE DRAWINGS

FIG. 1 is a diagram illustrating the major system components and their data flows in relationship to each other.

FIG. 2 is a diagram illustrating the Web content overlay process.

### DETAILED DESCRIPTION

The rapid growth of video data leads to an urgent demand for efficient and true content-based browsing and retrieving systems. In response to such needs, various video content analysis schemes using one or a combination of image, audio, and text information in videos have been proposed to parse, index, or abstract massive amount of data text in video is a very compact and accurate clue for video indexing and summarization. Most video text detection and extraction methods hold assumptions on text color, background contrast, and font style. Moreover, few methods can handle multilingual text well since different languages may have quite different appearances. Here, an efficient overlay text method is implemented which deals with complex backgrounds.

A video with Web content overlay is also known as a picture-in-picture or Web-on-video effect. This technique is used to superimpose Web content over a video or another display in the background.

ILAFVDO is a software module of ILA providing the method comprising receiving an interactive content file to be overlaid on a video, the interactive content file comprising: one or more interactive Web documents or pages arranged to be overlaid on the video when the video is played by the user device. The one or more interactive content overlay file(s) have associated information which is accessible by a user when selected via a user interface of the user device, and information defining as reference material to be overlaid on the video.

ILAFVWO is a software module of ILA providing a course producer with the ability to define one or more hotspots each corresponding to user interface locations where one or more Web content objects are displayed overlaying a video sequence.

Typically, the hotspots are not visible to a viewer when the video is played back, but if the viewer moves a cursor or other position indicator to the hotspot in a displayed, the hotspot is activated. A caption identifying the hotspot may be displayed and, if the viewer selects the hotspot, for example, by clicking a mouse button when the cursor is located on the hotspot, supplemental information stored in a separate computer-accessible file and related to the object corresponding to the hotspot is shown in an area of the display. The supplemental information related to the hotspot can contain any kind of Web content. Storing the supplemental information in a separate file facilitates updating of the information.

The list of types of Web content which the system is capable of overlaying onto video is comprising file types, language type contents, and programmatic frameworks:

HTML, HTM, WordPress, Angular, Java, React, Asp.net, PHP, Silverlight, JavaScript, VueJS, CSS, AJAX, Atom, Bootstrap, Core.js, DHTML, ASP, jQuery, JSS, Kendo, SAML, Socket.IO, Vanilla JS, WebGL, WinForms, WSDL, and XHTML.

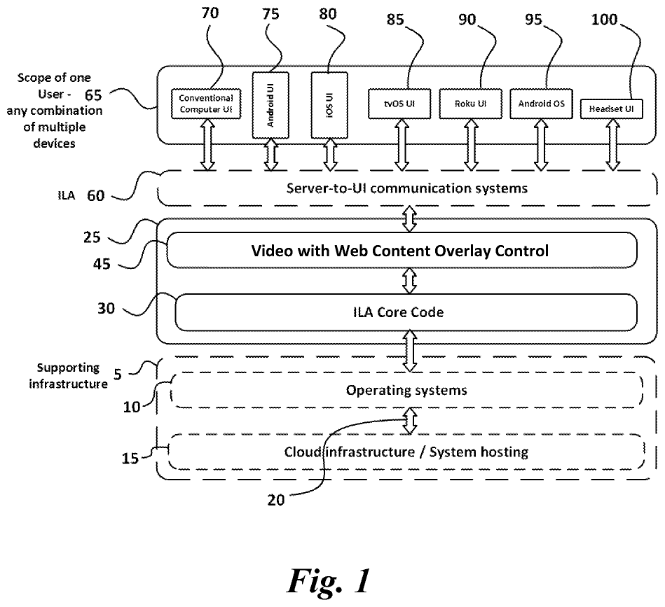

Referring to FIG. 1, ILA is supported in a context of other software which are not parts of which ILA is comprised but are necessary for ILA operating correctly. These components are illustrated in dashed outlines. A Supporting infrastructure 5 is comprised of a so-called cloud hosting environment of servers 15, operating systems 10, and Internet components in communication with each other by means of data flows 20, indicated generically by double arrows throughout FIG. 1. Communications between said servers and remote user devices is through generic Internet server-to-user-interface communication systems 60.

The software architecture of ILA 25 is comprising a body of core code 30, together with distinct modules providing specific services. The core code 30 in turn operates ILAFVWO 50, a module providing Web content overlaying video capability.

The module ILAFVWO 50 is communicating through said server-to-user-interface communication systems 60, to one or any combination of an array of user devices within the scope 65, the array of devices and displays comprising a conventional computer display 70, an Android user interface display 75, an iOS user interface display 80, a tvOS user interface display 85, a Roku user interface display 90, an Android OS user interface display 95, and a virtual reality headset user interface display 100.

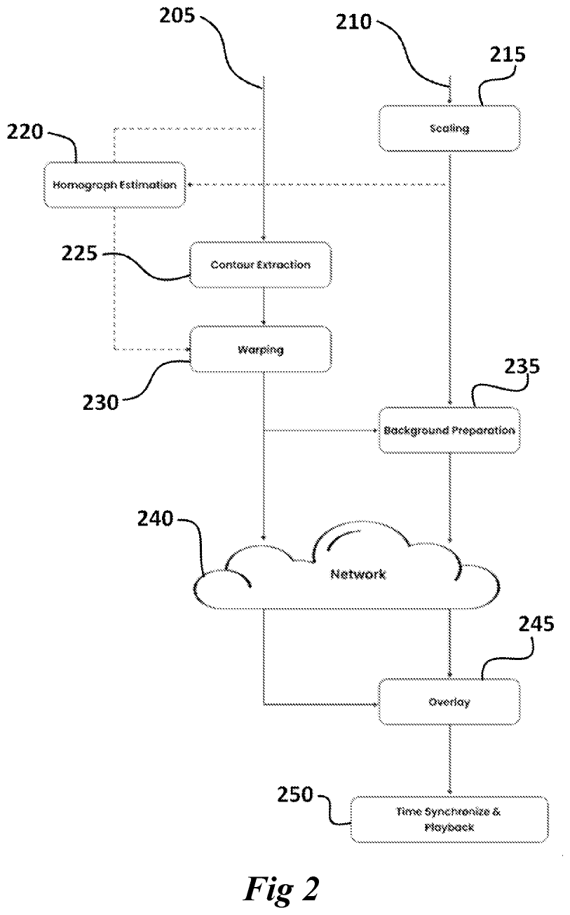

FIG. 2 illustrates the Web overlay process. Web content such as information, images, formats, background are extracted from any document 205, 210 and make single package to overlay on video with synchronization. The initial step is scaling 215 which by means of which computing size, pages, width and margins of document are accomplished. In this step, analysis is performed for the document based on the architecture which comprises of computation of the words in the units which can in turn quantify the data. Secondly, the homography estimation 220 creates a linear mapping of pixels between multiple images. This helps in the feature detection and transformation estimation stages. This is achieved by extracting and matching sparse feature points, which are error-prone in low-light or low-texture images.

When the object of interest provided has been detected, its region is identified using the simple background subtraction 235 and color segmentation method. The outer boundary points of the region are identified for the segmented region which gives the complete list of the contour points. Initially left and right ended contour points are detected and gradually complete list of the contour points are identified and extracted 225. This will detect and reorder all the contour points of the scene objects regardless of their shape and the starting point of the reordering. This will also hold three consecutive input lines at once instead of storing an entire image. The data coming from the contour extraction and homograph estimation is taken into warping. Reshaping of an image to align perspectives with another image is achieved by the process of warping 230. At the end the streams are decoded to obtain the frames and audio data. The packet delays are accounted for by sufficient buffering. The data is passed through the Internet network 240. The frames are overlayed 245 on the board frames at a ratio of 10:1 and played back at the rate of 30 frames per second. The audio data is synchronously played back 250 according to the time stamping.

We claim,

1: A software structure and operating means comprising
a) A centralized software structure serving as a framework for displaying and operating content on remote devices; and
b) support of video content on said remote device displays; and
c) support of and user control of displaying Internet Web content comprising HTML5, overlaying said video content, including user interaction with said Internet Web content; and
d) user control of layering of video and said Internet Web content displaying on user's remote devices; and
e) user control of display parameters of overlaid Internet Web content said parameters comprising presence, absence, minimization, maximization, scaling, opacity, and screen position.
f) Support of said overlaid Internet Web content over said video on remote operating systems comprising tvOS, Roku OS, iOS, and Android OS or any combination thereof.
